(19) United States
(12) Patent Application Publication
(10) Pub. No.: US 2017/0072732 A1
(43) Pub. Date: Mar. 16, 2017

(54) Volume Holograms for Security Documents

(71) Applicant: Innovia Security Pty Ltd, Craigieburn, Victoria (AU)

(72) Inventors: Odi Batistatos, Craigieburn, Victoria (AU); Gary Fairless Power, Craigieburn, Victoria (AU); Karlo Jolic, Craigieburn, Victoria (AU)

(73) Assignee: Innovia Security Pty Ltd, Craigieburn, Victoria (AU)

(21) Appl. No.: 15/305,711

(22) PCT Filed: Apr. 23, 2015
(86) PCT No.: PCT/AU2015/050193

§ 371 Date: Oct. 21, 2016

(30) Foreign Application Priority Data
Apr. 23, 2014 (AU) 2014901478

(51) Int. Cl. B42D 25/328; B42D 25/324; B42D 25/41; G03H 1/04; B42D 25/425; B42D 25/29; G03H 1/00; G03H 1/02; B41M 3/14; B42D 25/42

(52) U.S. Cl. CPC B42D 25/328; B41M 3/148; B42D 25/324; B42D 25/41; B42D 25/42; B42D 25/425; B42D 25/29; G03H 1/0011; G03H 1/0248; G03H 1/04; G03H 2001/0415; G03H 2260/12

(57) ABSTRACT

A method for producing a security document comprising a volume hologram, including the steps of: applying an optically sensitive material onto a first surface of a substrate in a first region of the first surface; and irradiating the optically sensitive material with patterned radiation configured for recording a volume hologram within the optically sensitive material.

### FIELD OF THE INVENTION

The invention relates generally to optical devices for documents, for example banknotes, such optical devices providing a security effect in the form of a volume hologram visual effect.

### BACKGROUND TO THE INVENTION

The use of holograms as a security device is well established in the field of security documents, such as banknotes, passports, cheques, share certificates and the like. Holograms are, potentially, less challenging to counterfeiters to replicate because they are, relatively, well known and, relatively, well understood.

In order to reduce the risk of counterfeiting, many advances have been made in the field of holograms. However, these technological advances are, generally, in the area relating to thin holograms. Where thick holograms (commonly known as volume holograms) have been investigated, it has been in relation to foils for attachment, for example by hot stamping, to a security document.

The process of hot stamping foils onto security documents has several disadvantages. For one, the foil can be prone to removal from the security document, which can aid in replication and furthermore which can prematurely end the life of the security document (which is of particular importance in the field of banknotes). Another issue is that foil design can limit the range of different designs employable with the banknote. Another disadvantage is that multiple steps are required corresponding to forming a hologram on the foil and stamping the foil onto the security document.

Some applications of security documents require a minimal thickness of applied features. The combined thickness of a foil and a volume hologram can in many instances result in a security device with a combined thickness greater than that suitable for use with the security document.

### SUMMARY OF THE INVENTION

It would therefore be desirable to provide for the production of volume hologram security devices which overcome the above noted problems.

According to a first aspect of the present invention, there is provided a method for producing a security document comprising a volume hologram, including the steps of: applying an optically sensitive material onto a first surface of a substrate in a first region of the first surface; and irradiating the optically sensitive material with patterned radiation configured for recording a volume hologram within the optically sensitive material.

Preferably, the optically sensitive material is applied using a printing and/or embossing process. Printing and/or embossing allows for various advantages, for example registration with other printed and/or embossed features of the security document, and/or the creation of complex shapes.

In an embodiment, the method includes the further step of applying a protective coating to an outwards facing surface of the optically sensitive material. The protective coating may be applied after the irradiation of the optically sensitive material with patterned radiation.

The substrate is preferably formed from polymeric material, preferably biaxially oriented polypropylene (BOPP). Also preferably, the optically sensitive material is a printable photopolymer.

Optionally, once applied, the optically sensitive material includes a substantially flat outward facing surface. The optically sensitive material is preferably not greater than about 20 microns thick, more preferably not greater than about 10 microns thick.

In an alternative option, once applied, the optically sensitive material includes a non-flat outward facing surface, such that the optical sensitive material provides a further optical effect in addition to providing a volume hologram. Preferably, the outward facing surface is shaped as an arrangement of microlenses or is shaped as a diffraction grating. Advantageously, this option allows for the combination of known optical effects typically created using radiation curable inks with the volume hologram effect recorded into the optically sensitive material. This option may be particularly applicable to embodiments utilising a photopolymer as the optically sensitive material.

The minimum thickness of the optically sensitive material is preferably sufficient to record a volume hologram.

In an embodiment, the method includes the step of: applying a first opacifying layer to the first surface, the first opacifying layer being omitted in a first window region, wherein the optically sensitive material is located within the first window region. The area of the first window region may be greater than, equal to, or less than the area of the optically sensitive material. Preferably, the first opacifying layer and the optically sensitive material are applied in registration, such that the first window region is registered with the optically sensitive material. The embodiment may include the step of applying a second opacifying layer to a second surface of the substrate. The second opacifying layer may be configured to partially or entirely cover the optically sensitive material, such that where the second opacifying layer covers the optically sensitive material, the volume hologram is only visible from the first surface. Alternatively, the second opacifying layer may be omitted in a second window region, wherein the optically sensitive material is visible through the second window region of the second opacifying layer. The, or each, opacifying layer is preferably applied after the irradiation with patterned radiation.

Optionally, a primer layer is applied to the first surface such that the optically sensitive material is applied to the primer layer. One preferred primer material is polyethylene imine.

Optionally, the patterned radiation is provided by one or more lasers. The patterned radiation may be created in part through reflection of laser radiation off an object and/or the patterned radiation may be created in part through the provision of a master hologram. Preferably, the patterned radiation includes wavelengths selected from one or more of the visible spectrum, infra-red spectrum, and ultra-violet spectrum.

According to another aspect of the present invention, there is provided a security document including a substrate having a first opacifying layer applied to a first surface, the first opacifying layer including a first window region in which a volume hologram is located, said volume hologram formed from an optically sensitive material applied to the first surface.

The optically sensitive material may be applied directly to the first surface. Alternatively, the substrate may include a primer layer, and the optically sensitive material is applied directly to the primer layer.

Optionally, the substrate has a second opacifying layer applied to a second side. The second layer may partially or entirely cover the volume hologram. Alternatively, the second layer may include a second window region substantially in register with the first window region in which the volume hologram is located, such that the volume hologram is located in a window of the security document.

According to another aspect of the invention, there is provided a security document produced according to the method of the first aspect.

A security documents according to an aspect of the invention is preferably a banknote.

Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The devices described herein may also have application in other products, such as packaging.

Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting at least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

Refractive Index

The refractive index of a medium n is the ratio of the speed of light in vacuum to the speed of light in the medium.

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIG. 1 shows a security document including a security device having a volume hologram and an optional security feature;

FIG. 2a shows a substrate;

FIG. 2b shows the substrate including an optically sensitive material (OSM) applied to a region of a first surface of the substrate;

FIG. 2c shows the security device located within a half-window region of the security document;

FIG. 2d shows the security device located within a window region of the security document;

FIG. 2e shows the security device located within a window region and an optional security feature located within a half-window region;

FIG. 3 shows a reference beam and an imaging beam incident onto opposite sides of the OSM;

FIG. 4 shows an apparatus for recording a volume hologram;

FIG. 5a shows the OSM with an outward facing surface shaped as an arrangement of microlenses; and

FIG. 5b shows the OSM with an outward facing surface shaped as a diffraction grating.

### DESCRIPTION OF PREFERRED EMBODIMENT

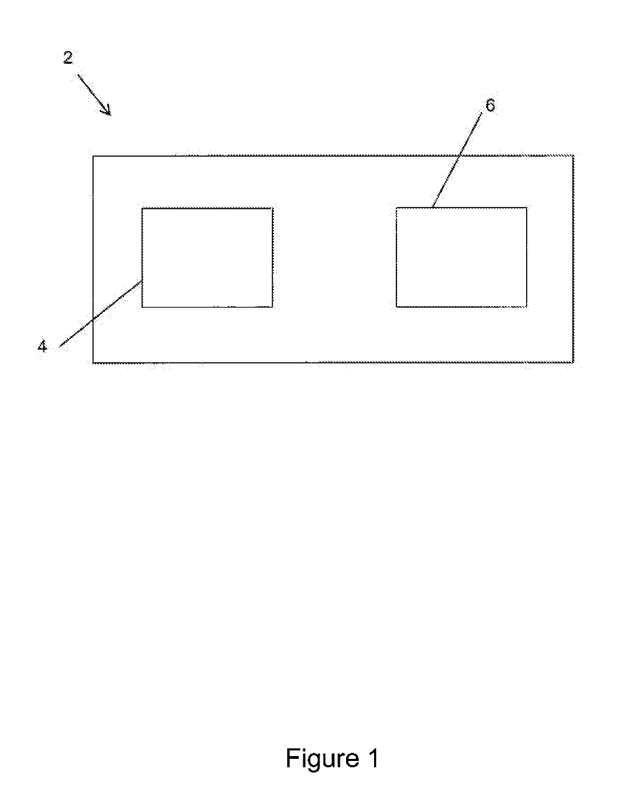

Referring to FIG. 1, there is shown a security document 2 including an optical device 4, preferably providing the functionality of a security device, and one or more optional security features 6. The optional security features 6 can be, for example, further optical-based devices such as optically variable devices. The optical device 4 can be located within a window or half-window region of the security document 2. The optical device 4 is a volume hologram providing a visual effect.

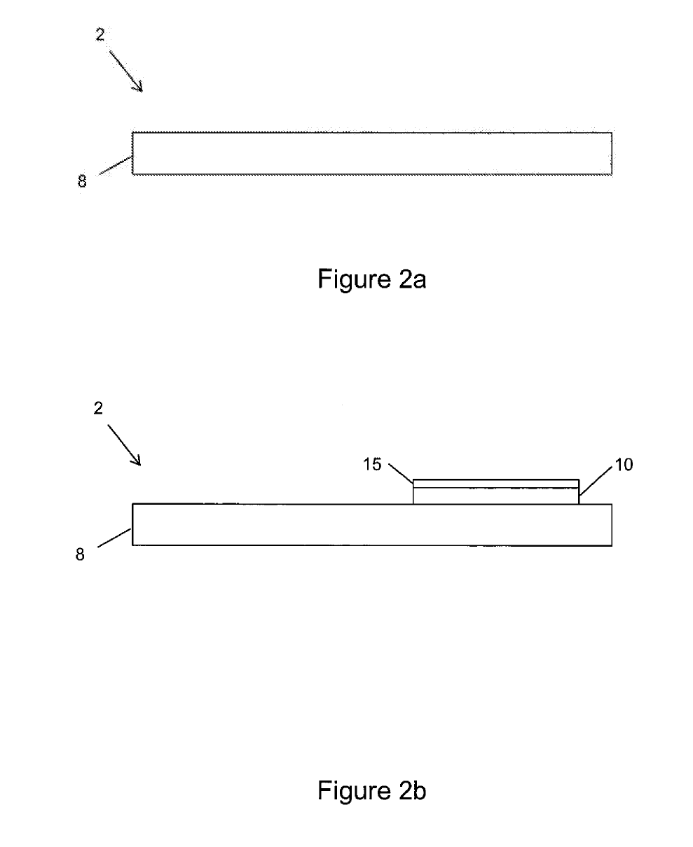

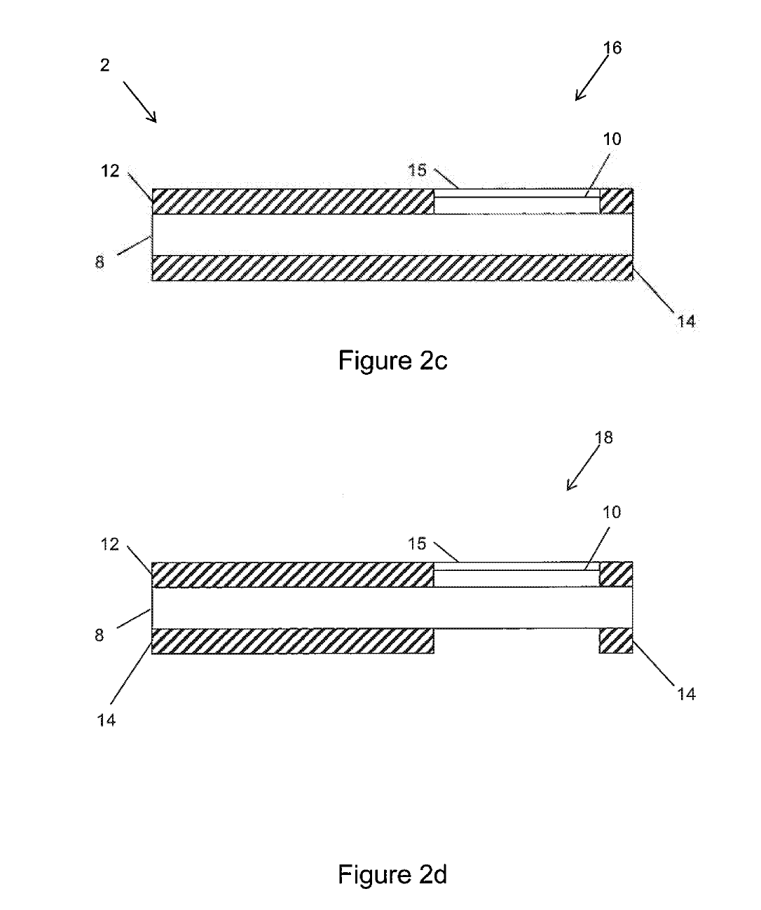

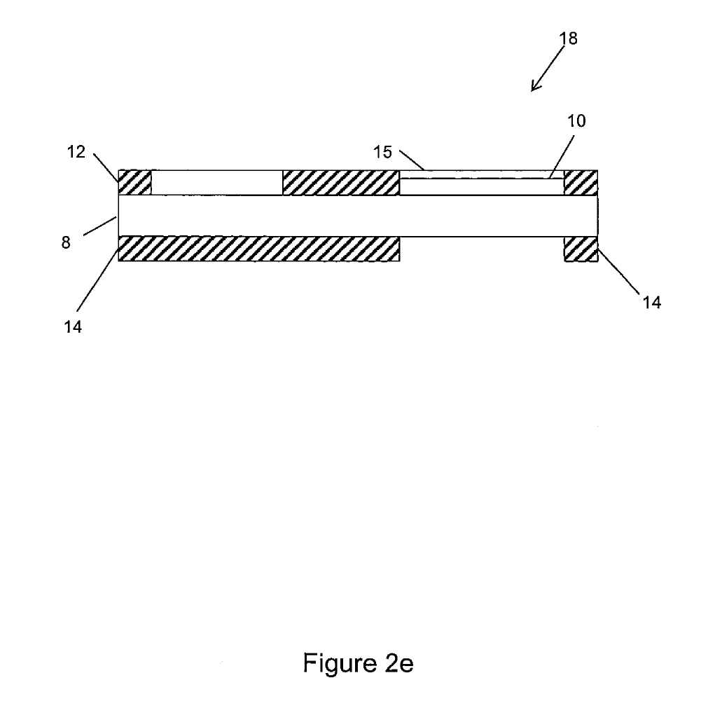

Referring now to FIGS. 2a to 2e, a method for producing a security document 2 including an optical device 4 corresponding to a volume hologram is shown. Initially, there is provided a substrate 8 (FIG. 2a). The substrate 8 can be a polymer substrate, for example based on biaxially oriented polypropylene (BOPP). Such a substrate 8 is typically transparent or translucent. An optically sensitive material (OSM) 10 is directly applied to a region of a surface of the substrate as shown in FIG. 2b (the optional protective coating 15 is described below).

In an embodiment, the OSM 10 is applied using printing and/or embossing techniques. However, other printing methods suitable for directly applying the OSM 10 onto the region of the surface of the substrate 8 may be utilised. The OSM 10 is a printable photopolymer suitable for recording a volume hologram.

One form of printing which allows for accurate registration is Simultan printing. Other suitable forms of printing/embossing include gravure printing and intaglio printing. These printing/embossing techniques also allow for accurate registration.

Registration between the OSM 10 and the substrate 8 can beneficially provide a means for ensuring that the OSM 10 is applied in substantially the same region of each substrate 8 of a plurality of substrates in a continuous printing process. Printing/embossing techniques also allow for accurate registration with a region corresponding to a window or half-window.

FIGS. 2c to 2e show different embodiments of the security document 2 including the OSM 10, a first opacifying layer 12, and a second opacifying layer 14. The opacifying layers 12, 14 can be applied using known printing techniques such as gravure printing, and can be applied to form half-window or full window areas in registration with the OSM 10.

FIG. 2c corresponds to an embodiment with the second opacifying layer 14 applied to the substrate 8 in the region where the optical device 4 is located so that the optical device 4 is located within a half-window region 16 of the security document 2. In this embodiment, the volume hologram will be visible from one side of the security document 2 only.

FIG. 2d corresponds to an embodiment with the second opacifying layer 14 omitted in the region where the optical device 4 is located so that the optical device 4 is located within a full window region 18 of the security document 2. In this embodiment, the volume hologram can be visible from one side or both sides of the security document 2, depending on the configuration of the volume hologram.

It is also possible for another security feature, such as another volume hologram or other optically variable feature, to be provided on the opposite of the substrate 8 from the OSM 10, either in the half-window 16 of FIG. 2c or within the full window region 18 of FIG. 2d.

FIG. 2e corresponds to an embodiment wherein the optical device 4 is located within a window region 18 of the security document 2, and an optional security feature 6 is located within a half-window region 20 (though it is understood that the optional security feature 6 could be located in a window region). The half-window region 20 (or, equivalently, the window region) of the optional security feature 6 can be contiguous or separate to the window 18 or half-window 16 region of the optical device 4.

Though two opacifying layers 12, 14 are shown in each of FIGS. 2c to 2e, it is envisaged that only one opacifying layer 12 or 14 may be applied. It is also possible for more than one opacifying layer to be provided on one or both sides of the substrate 8, and/or for the thicknesses of the opacifying layers 12, 14 to be varied, e.g. to create shadow images. Furthermore, though the first opacifying layer 14 is shown in contact with the OSM 10, it may be that the OSM 10 is located within, and not bordering, the first opacifying layer 12. Opacifying layers 12, 14 allow for printing, for example of images and/or patterns, on the substrate 8. Opacifying layers 12, 14 can be a single colour, for example white, suitable for subsequent printing of images and/or patterns and/or text etc. Registration can allow for precise and/or consistent relative positioning between the OSM 10 and any images and/or patterns, such that each security document 2 produced is identical or at least substantially identical.

The OSM 10 can be applied such that the average and/or total thickness of the OSM 10 is not more than about 20 microns, preferably not more than about 10 microns. It can be advantageous to provide a suitably thin OSM 10 such that the optical device 4 formed by the OSM 10 is suitable for use in a print feed. In order to be able to record a volume hologram within the OSM 10, there exists a minimum thickness suitable for the OSM 10, which can be determined, for example, through experiment and/or calculation. Preferably, the minimum thickness is such that the resulting hologram is not a “thin” hologram. The OSM 10 can be applied in the form of a patch or stripe. Alternatively, the OSM 10 can be applied such that a complex shape with varying shape and/or size is defined. In one example, the OSM 10 is printed such that it defines internal areas not containing a volume hologram.

In an embodiment, in order to assist with adhesion of the OSM 10, the substrate 8 includes a primer layer, at least in the region of the OSM. The primer layer preferably includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodi-imides. The primer layer may itself include multiple layers.

Before the opacifying layers 12, 14 are applied to the substrate 8, the OSM 10 is exposed to patterned radiation, preferably sourced from a laser. Alternatively, the OSM 10 can be exposed to the patterned radiation after application of the opacifying layers 12, 14, which may be particularly applicable when the OSM 10 is located within a window region of the security document 2. The OSM 10 is initially responsive to incident light, wherein the OSM 10 can be sensitive to a wide-range of wavelengths, or a specified range of wavelengths. Said wavelengths can be, for example, in one or more of the visible spectrum, infra-red spectrum, and ultra-violet spectrum. The OSM 10 is configured for recording a pattern of radiation intensity, through local changes in refractive index in proportion to local radiation intensity.

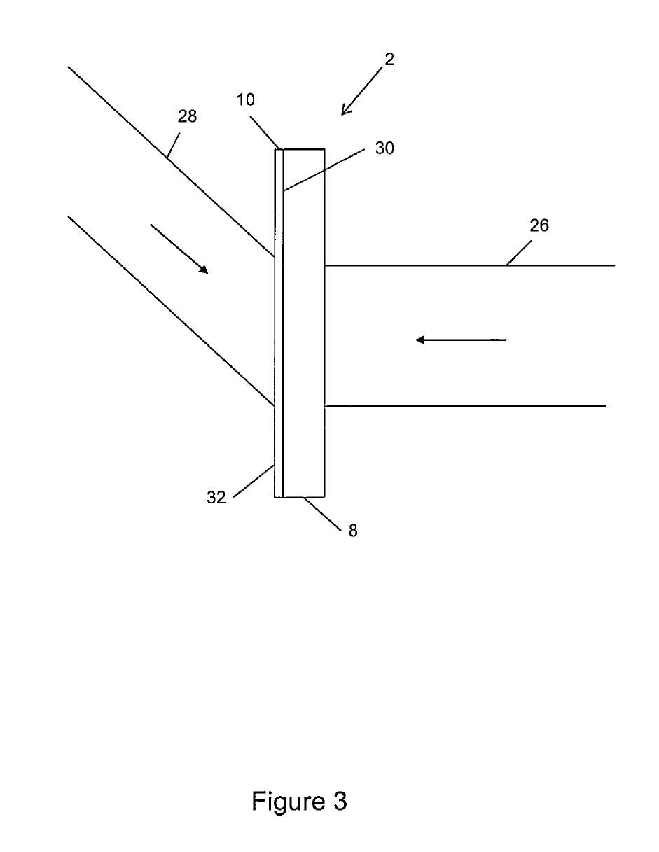

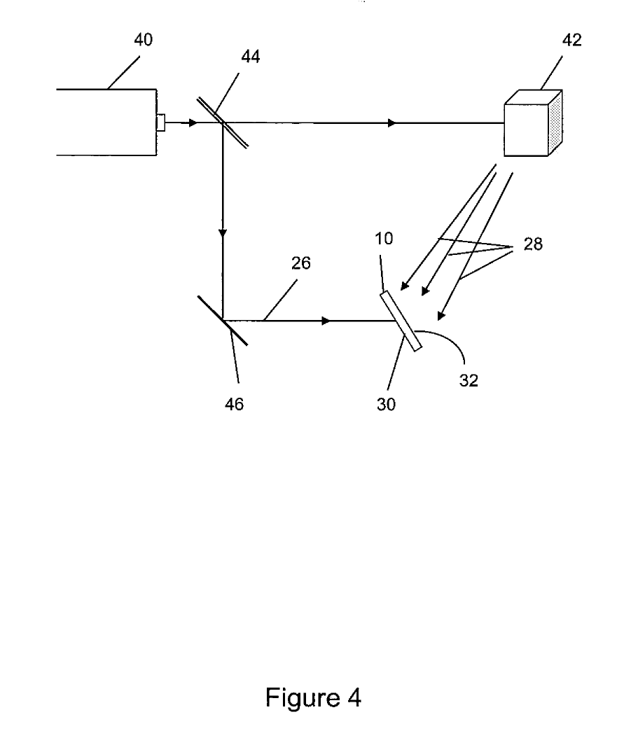

The patterned radiation may be provided using known volume holographic preparation techniques. In general, a reference beam 26 and an imaging beam 28 are directed such as to create an interference pattern within the OSM 10 (the inference pattern corresponds to the patterned radiation). This can be achieved, with reference to FIGS. 3 and 4, by directing the reference beam 26 onto a first surface 30 of the OSM 10, and the imaging beam 28 onto a second surface 32 of the OSM 10, wherein either the reference beam 26 or the imaging beam 28 is directed through the substrate 8, thereby creating a reflection-type volume hologram. The reference beam 26 corresponds to coherent radiation directly sourced from the laser. The imaging beam 28 corresponds to patterned radiation. The patterned radiation of the imaging beam 28 is, usually, sourced from the same coherent source of radiation 40 as the reference beam, but is first either reflected or transmitted through a master volume hologram, or alternatively scattered from an object, before being incident onto the second surface 32, as shown in the apparatus of FIG. 4. The apparatus may also include a beam splitter 44 and one or more mirrors 46 for directing the reference beam 26 and/or imaging beam 28 onto the OSM 10.

In an alternative arrangement, both the reference beam 26 and imaging beam 28 are directed onto the same side of the OSM 10, creating a transillumination-type volume hologram. Embodiments having the optical device 4 located in a full window (such as shown in FIG. 2d) may be particularly suitable for this arrangement.

A master volume hologram 42 will produce an imaging beam 28 corresponding to an original imaging beam used to create the master volume hologram 42, on transmission or reflection of incident coherent radiation (i.e. a reference beam). Therefore, a master volume hologram 42 creates the same imaging beam 28 as scattering off an object, where the object is the same object as was used to create the master volume hologram 42.

One exemplary technique for recording a volume hologram into the OSM 10 is to direct an incident reference beam 26 through the first surface 28 of the OSM 10, and providing a reflective master volume hologram 32 adjacent the second surface 30 of the OSM 10 (either directly adjacent or including a spacing). When the reference beam 26 is reflected from the master volume hologram 26, it is effectively modulated into the imaging beam 28, and is directed onto the second surface 28 due to the reflection. This imaging beam 28 is then able to create the appropriate interference pattern within the OSM 10 due to interference with the reference beam 26.

Volume holograms can be angularly and wavelength dependent. Therefore, multiple images can be recorded within the OSM 10, for example by simultaneously or sequentially irradiating the OSM 10 with laser light of different wavelength and/or with different incident angles for the reference beam 26.

The OSM 10 can be desensitised during the exposure to the patterned light, such that no further change in the optical properties of the OSM 10 occurs after the volume hologram has been recorded. However, a bleaching step can be included after exposure to the patterned light in order to improve the optical transparency of the OSM 10. The bleaching step can correspond to irradiation with UV light.

Optionally, a protective coating 15 is applied to the OSM 10, before or after recoding the interference pattern and/or desensitising the OSM 10. This is particularly useful when the OSM material is not sufficiently durable for the intended task (for example, for extensive public use when used with banknotes). The protective coating 15 should be transparent or at least substantially transparent, such that the quality of the volume hologram is not noticeably diminished by the presence of the protective coating 15. Alternatively, the protective coating 15 is transparent only to a selection of wavelengths, thereby acting as a filter.

In order to increase the visibility of the volume hologram optical effect, the OSM 10 can be positioned adjacent a dark, preferably black, background. Such background can be created by applying a printed patch to the substrate 8.

According to an embodiment, the OSM 10 has a non-flat outward facing surface. Such an arrangement can provide for interesting further optical effects in addition to the volume hologram recorded into the OSM 10. In one implementation, the OSM 10 is applied using an embossing process and the embossing tool includes a non-planar profile, the reverse of which it imparts onto the OSM 10.

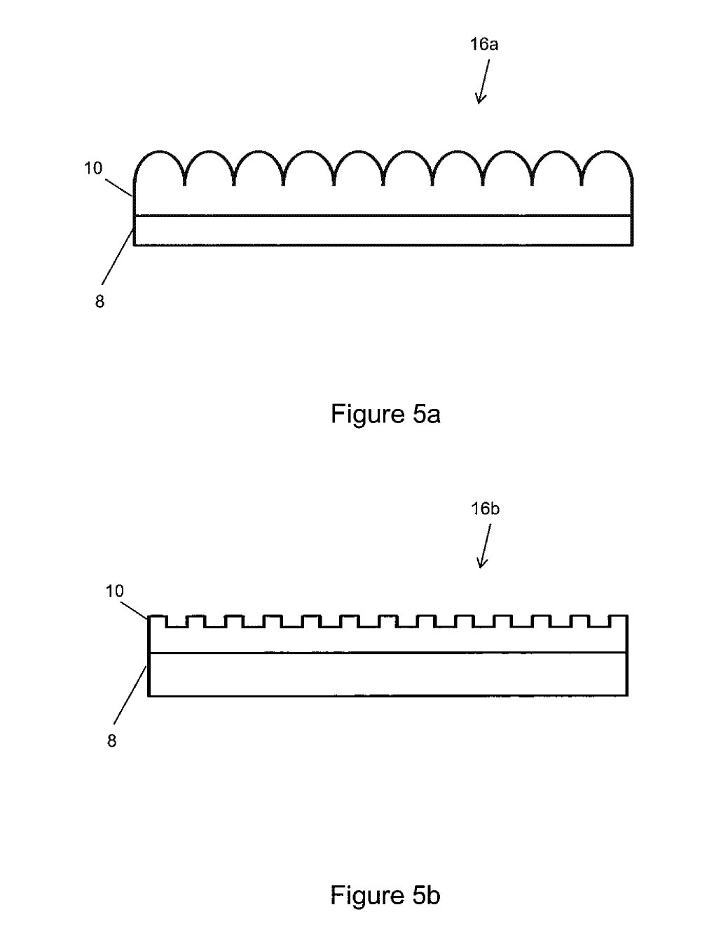

FIG. 5a shows the OSM 10 applied to the substrate 8 and including an outward facing surface 16a shaped as to form an array of microlenses. The OSM 10 in this case has a sufficiently different refractive index to air (as shown) or a protective coating applied to the OSM 10 (not shown) required to provide a refractive lens effect. The OSM 10 thereby provides both a volume hologram optical effect (the volume hologram is recorded as described herein) and a microlens array effect. Such microlens arrays can be utilised in a number of known ways in order to provide additional security to the security document 2, for example as part of a moiré optical device, a contrast switch, or an integral imaging device. The OSM 10 may be positioned overlapping a printed pattern configured to interact with the microlenses in order to provide the additional optical effect. Suitable printed patterns include arrangements of microimages.

FIG. 5b shows the OSM 10 applied to the substrate 8 and including an outward facing surface 16b shaped as to form a diffraction grating, which may be a thin hologram. Similar to FIG. 5a, the OSM 10 has a sufficiently different refractive index to air (as shown) or a protective coating applied to the OSM 10 (not shown) required to provide a diffractive effect.

Further modifications and improvements may be made without departing from the scope of the present invention. For example, the master volume hologram may be replaced with a diffractive-based optical device, for example a Kinegram®, a simple blazed diffraction grating, etc. Another embodiment may utilise the known technique of double soft-embossing to emboss, in register, optically sensitive materials on each side of the substrate.

1.-30. (canceled)

31. A method for producing a security document comprising a volume hologram, including the steps of:
a) applying an optically sensitive material onto a first surface of a substrate in a first region of the first surface; and
b) irradiating the optically sensitive material with patterned radiation configured for recording a volume hologram within the optically sensitive material.

32. A method as claimed in claim 31, where the optically sensitive material is applied using a printing and/or embossing process.

33. A method as claimed in claim 31, including the further step of applying a protective coating to an outwards facing surface of the optically sensitive material.

34. A method as claimed in claim 33, wherein the protective coating is applied after the irradiation of the optically sensitive material with patterned light.

35. A method as claimed in claim 31, wherein the substrate is formed from a polymeric material, preferably biaxially oriented polypropylene.

36. A method as claimed in claim 31, wherein the optically sensitive material is a printable photopolymer.

37. A method as claimed in claim 31, wherein once applied, the optically sensitive material includes a substantially flat outward facing surface.

38. A method as claimed in claim 31, wherein once applied, the optically sensitive material includes a non-flat outward facing surface, such that the optical sensitive material provides a further optical effect in addition to providing a volume hologram.

39. A method as claimed in claim 38, wherein the outward facing surface is shaped as an arrangement of microlenses or is shaped as a diffraction grating.

40. A method as claimed in claim 31, wherein the thickness of the optically sensitive material is not greater than 20 microns, preferably not greater than 10 microns.

41. A method as claimed in claim 40, wherein the minimum thickness of the optically sensitive material is sufficient to record a volume hologram.

42. A method as claimed in claim 31, including the step of: applying a first opacifying layer to the first surface, the first opacifying layer being omitted in a first window region, wherein the optically sensitive material is located within the first window region.

43. A method as claimed in claim 42, wherein the first opacifying layer and the optically sensitive material are applied in registration, such that the first window region is registered with the optically sensitive material.

44. A method as claimed in claim 42, including the step of applying a second opacifying layer to a second surface of the substrate.

45. A method as claimed in claim 44, wherein the second opacifying layer is configured to partially or entirely cover the optically sensitive material, such that where the second opacifying layer covers the optically sensitive material, the volume hologram is only visible from the first surface.

46. A method as claimed in claim 44, wherein the second opacifying layer is omitted in a second window region, wherein the optically sensitive material is visible through the second window region of the second opacifying layer.

47. A method as claimed in claim 42, wherein the, or each, opacifying layer is applied after the irradiation with patterned radiation.

48. A method as claimed in claim 31, wherein the substrate includes a primer layer, such that the optically sensitive material is applied directly to the primer layer.

49. A method as claimed in claim 48, wherein the primer includes a polyethylene imine.

50. A method as claimed in claim 31, wherein patterned radiation is provided by one or more lasers.

51. A method as claimed in claim 50, wherein the patterned radiation is created at least in part through reflection of laser radiation of an object.

52. A method as claimed in claim 50, wherein the patterned radiation is created at least in part through the provision of a master hologram.

53. A method as claimed in claim 31, wherein the patterned radiation includes wavelengths selected from one or more of the visible spectrum, infra-red spectrum, and ultra-violet spectrum.

54. A security document including a substrate having a first opacifying layer applied to a first surface, the first opacifying layer including a first window region in which a volume hologram is located, said volume hologram formed from an optically sensitive material applied to the first surface.

55. A security document as claimed in claim 54, wherein the substrate includes a primer layer, and wherein the optically sensitive material is applied directly to the primer layer.

56. A security document as claimed in claim 54, wherein the substrate has a second opacifying layer applied to a second side.

57. A security document as claimed in claim 56, wherein the second layer partially or entirely covers the volume hologram.

58. A security document as claimed in claim 66, wherein the second layer includes a second window region substantially in register with the first window region in which the volume hologram is located, such that the volume hologram is located in a full window of the security document.

59. A security document produced by the method of claim 31.

60. A security document as claimed in claim 54, wherein the security document is a banknote.
